(19) United States
(12) Patent Application Publication
(10) Pub. No.: US 2023/0024491 A1
(43) Pub. Date: Jan. 26, 2023

(54) METHOD FOR FORMING AIRTIGHT STRUCTURE OF ELECTROACOUSTIC DEVICE AND AIRTIGHT STRUCTURE THEREOF

(71) Applicant: MEILOON INDUSTRIAL CO., LTD., Taoyuan (TW)

(72) Inventors: Tan-Chih WU, Taoyuan (TW); Chia-Yen LI, Taoyuan (TW); Hung-Wei CHEN, Taoyuan (TW); Yi-Ku HUANG, Taoyuan (TW); Chene-Lun LEE, Taoyuan (TW); Ting-Yu WANG, Taoyuan (TW); Hsuan-Yi LIAO, Taoyuan (TW); Sheng-Wei CHEN, Taoyuan (TW); Jen-Hsin CHAN, Taoyuan (TW)

(21) Appl. No.: 17/383,771

(22) Filed: Jul. 23, 2021

(51) Int. Cl. H04R 1/02; B29C 65/52; B29C 65/48

(52) U.S. Cl. CPC H04R 1/025; B29C 65/524; B29C 65/4845; B29L 2031/3418

(57) ABSTRACT

A method is provided forming an airtight structure of an electroacoustic device which includes a body shell composed of at least two half-shells and at least one airtight structure region. The method includes providing an automatic glue dispensing device for dispensing and pre-curing a photo-curing glue for one of the two half-shells, putting the half-shell into a photo-curing device to convert the photo-curing glue pre-cured completely into an elastomer, and combining the half-shell and the other one to have a pressing wall of the other half-shell to press the elastomer to form the airtight structure of the electroacoustic device, wherein the automatic glue dispensing device includes a glue dispensing head moving on a groove of the airtight region of the half-shell for dispensing the photo-curing glue and a pre-curing head continuously providing a curing light ray for pre-curing the photo-curing glue.

### FIELD OF THE INVENTION

The invention relates to a method for forming an airtight structure of an electroacoustic device and the airtight structure thereof, in particular to a forming method for preparing the airtight structure of the electroacoustic device by using an automatic glue dispensing device and photo-curing glue and the airtight structure thereof.

### BACKGROUND OF THE INVENTION

The electroacoustic device is provided with a shell, and the shell is composed of at least two half-shells. In order to maintain the airtight function of the electroacoustic device, the electroacoustic device is provided with a plurality of airtight regions on the shell by a manufacturer, and a conventional manufacturing method of the airtight regions mainly includes that EVA (ethylene vinyl acetate) foaming foam, gaskets and the like are manually adhered to one of the two half-shells, the two half-shells are joined later, and the airtight effect can be achieved after the two half-shells are joined.

As an example, the EVA foaming foam is conventionally manufactured by firstly forming the EVA material through a die, then pasting back glue on the EVA material and cutting the EVA material to form the foaming foam which accords with the pattern of an airtight region. However, due to the fact that the material characteristics of the EVA material are soft and rich in elasticity, the EVA foaming foam cannot be taken by automatic equipment, so that the shell preparation of the traditional electroacoustic device must manually adhere the EVA foaming foam to the half-shell.

In addition, if the shell manufactured by the preparation method is complex in airtight region shape or wide in airtight region range, operators must repeat the bonding operation for many times, so that the preparation steps are complicated, and the preparation time is prolonged. In addition, because the shape of the EVA foaming foam is fixed, when the sample state of the airtight region is too complex, the EVA foaming foam is easy to be in the condition that the two half-shells cannot be tightly adhered, so that the airtight function of the electroacoustic element is poor.

In addition, in order to improve the problem that EVA foaming foam cannot be tightly adhered to the two half-shells, manufacturers of current electroacoustic devices have changed to apply colloids, as disclosed in patents CN 109587604A, CN 109306255A, CN 110028925A, CN 210724969U and CN 106535070A. In the case of CN 109587604A, although the patent discloses coating the two half-shells with a thin layer of glue and bonding the two half-shells through photo-curing, the conventional glue only bonds the two parts and cannot be used for airtight purposes, so that the airtight function of the electroacoustic element cannot be improved.

### SUMMARY OF THE INVENTION

The invention mainly aims to solve the problem that the conventional mode is not favorable for preparing an electroacoustic device.

Another object of the invention is to improve the problem that the conventional materials are insufficient to surely provide an airtight function of an electroacoustic structure.

In order to achieve the object, the invention provides a method for forming an airtight structure of an electroacoustic device; the electroacoustic device comprising a body shell composed of at least two half-shells and set with at least one airtight region, wherein the invention comprises the following steps:

step one: providing an automatic glue dispensing device, wherein the automatic glue dispensing device comprises a glue dispensing head and a pre-curing head, the pre-curing head moves along a track of the glue dispensing head, and a curing light ray is provided after the pre-curing head is started;

step two: providing one of the at least two half-shells, wherein the half-shell is provided with at least one groove at a position expected to form the airtight region;

step three: controlling the glue dispensing head to move based on the groove and to provide a photo-curing glue for the groove in a moving process, the pre-curing head continuously providing the curing light ray in the moving process, and enabling the photo-curing glue in the groove to be irradiated for a short time;

step four: putting one of the half-shells which is finished with step three into a photo-curing device, so that the photo-curing glue is completely converted into an elastomer in a solid state; and

step five: combining the at least two half-shells, the other half-shell pressing the elastomer in the groove by a pressing wall arranged at a position expected to form the same airtight region, thereby completing an airtight structure of the electroacoustic device.

In one embodiment, the groove is formed between two spaced walls.

In one embodiment, at least one of the two walls serves as the pressing wall for pressing the elastomer on the other half-shell.

In one embodiment, the pre-curing head moves in synchronization with the glue dispensing head.

In one embodiment, the automatic glue dispensing device comprises a mechanical arm and a holder provided at an end of the mechanical arm, and the glue dispensing head and the pre-curing head are both provided on the holder.

In one embodiment, the curing light ray comprises a wavelength of 310 nm to 365 nm and an illumination intensity of more than 50 mW/cm².

In one embodiment, an apex of the elastomer is not higher than a top edge of the groove.

In addition to the foregoing, the invention also provides an airtight structure of an electroacoustic device; the electroacoustic device comprising a body shell composed of at least two half-shells and set with at least one airtight region. One of the at least two half-shells is provided with an elastomer arranged in a groove at a position expected to form the airtight region, and the other of the at least two half-shells is provided with a pressing wall at a position expected to form the same airtight region, and when the at least two half-shells are assembled, the pressing wall presses the elastomer in the groove to form the airtight structure, wherein the elastomer is formed by a photo-curing glue which is arranged in the groove and is completely cured.

In one embodiment, the groove is formed between two spaced walls.

In one embodiment, at least one of the two walls serves as the pressing wall for pressing the elastomer on the other half-shell.

In one embodiment, an apex of the elastomer is not higher than a top edge of the groove.

Through the implementation of the invention, compared with the conventional use, the invention comprises the following characteristics: the forming method provided by the invention can be carried out by using the automatic equipment, the photo-curing glue is filled in the groove of one of the two half-shells through the glue dispensing head, and the photo-curing glue is irradiated for a short time along the track of the glue dispensing head by using the pre-curing head, so that the photo-curing glue can be fixed in the groove, and the time required for subsequently completely converting the photo-curing glue into the elastomer is reduced.

### BRIEF DESCRIPTION OF THE DRAWINGS

FIG. 1 is a schematic view of a structure of a body shell of the invention;

FIG. 2 is a schematic view of a structure of one of half-shells of the invention before it is filled with glue;

FIG. 3 is a schematic view of a structure of the other of the half-shells of the invention before it is filled with glue;

FIG. 4 is a step diagram of the forming method of the invention;

FIG. 5 is a schematic view of a structure of one of the half-shells of the invention before it is filled with glue;

FIG. 6 is a schematic view of a structure of the other of the half-shells of the invention when it is filled with glue;

FIG. 7 is a schematic view of implementation of an automatic glue dispensing device of the invention;

FIG. 8 is a schematic view of implementation of the half-shell of the invention filled with glue entering a photo-curing furnace.

### DETAILED DESCRIPTION OF THE PREFERRED EMBODIMENTS

The detailed description and technical contents of the invention will now be described with reference to the drawings as follows:

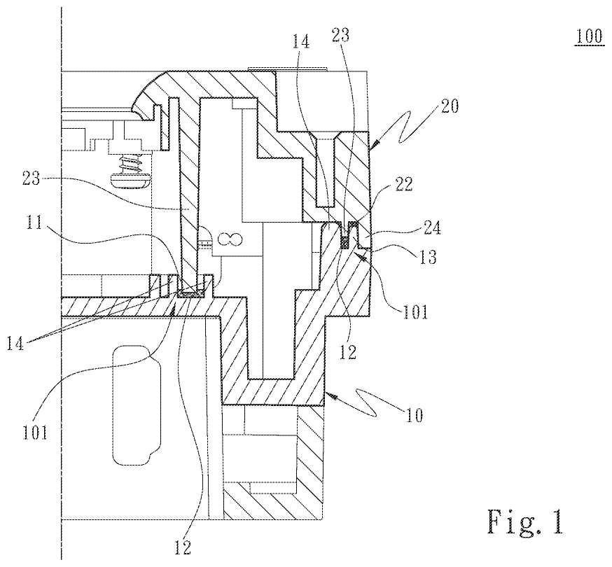

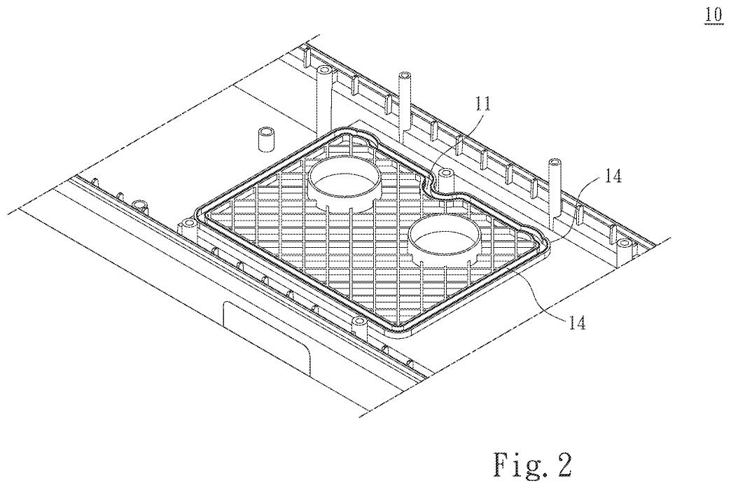

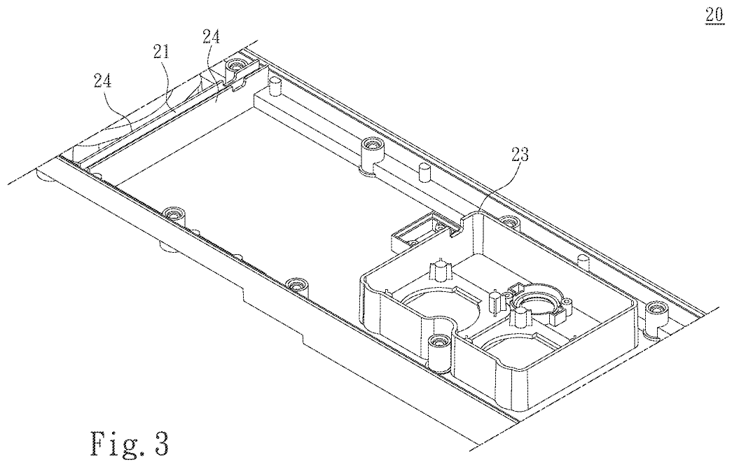

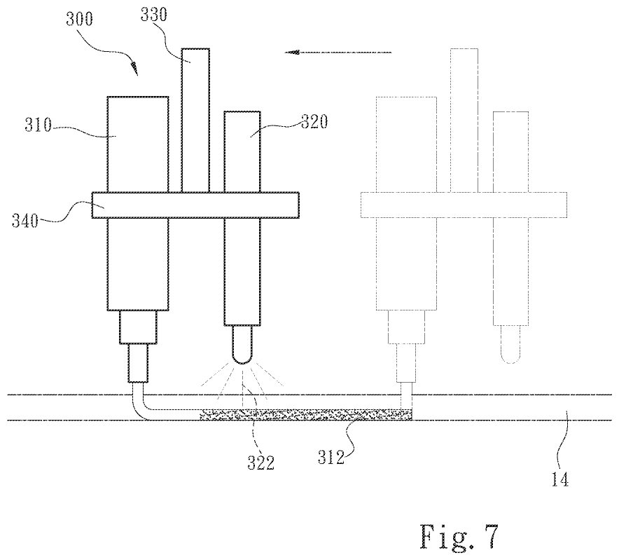

With reference to FIG. 1, FIG. 2, and FIG. 3, an airtight structure of an electroacoustic device according to the present application is intended to provide an acoustic cavity required for sound production of a loudspeaker, or for waterproofing, while the main ones used to form the airtight structure are the structural arrangements of integrally photocured elastomers 12, 22 and at least two half-shells 10, 20. In particular, the two half-shells 10, 20 are correspondingly arranged and combined to form a body shell 100 of the electroacoustic device, while the two half-shells 10, 20 at the moment of design are set with at least one airtight region 101 based on the implementation requirements of the electroacoustic device. One of the two half-shells 10, 20 is provided with a groove (11 or 21) at a position intended to form the airtight region 101 and an elastomer (12 or 22) provided in the groove (11 or 21), and the other of the at least two half-shells 20, 10 is provided with a pressing wall (23 or 13) at a position intended to form the same airtight region 101. The elastomer (12 or 22) comprises the characteristics of flexibility, cold and hot impact resistance, low shrinkage, shock absorption, air tightness, water resistance and the like, and is formed by a photo-curing glue 312 arranged in the groove (11 or 21), as shown in FIG. 7. The photo-curing glue 312 of the invention is optionally peelable after curing. In one embodiment, the composition of the photo-curing glue comprises a prepolymer elastomer, Urethane Acrylate, High boiling Methacrylate Acid, Silica, Acrylic Acid, and a photo-initiator. Further, in one embodiment, photo-initiators are not limited to a single species, and the photo-curing glue 312 may include a plurality of types of photo-initiators comprising different reaction wavelengths, and the concentrations of the components of the photo-initiators may not be fixed, depending on implementation requirements. For example, the photo-curing glue 312 contains two photo-initiators, one of which comprises a concentration ranging 1 WT. % to 2 WT. % and absorption spectrum of 260 nm to 360 nm, and the other of which comprises a concentration ranging 0.5 WT. % to 2 WT. % and absorption spectrum of 245 nm to 370 nm. Also, when the photo-curing glue 312 contains a plurality of photo-initiators, it is more effective to control the pre-curing to be produced by the method described later in the invention. In addition, after the photo-curing glue 312 adopted by the present invention is completely converted into the elastomer (12 or 22), the elastomer (12 or 22) is elastic, but the elastic characteristic of the elastomer (12 or 22) is not used for feeding back an acting force of the other half-shell (20 or 10), but is deformed when the other half-shell (20 or 10) is pressed for airtight of the at least two half-shells 10, 20. For example, when the elastomer (12 or 2) comprises a preferable amount of deformation and the elastomer (12 or 22) is pressed by one of the pressing walls (13 or 23) implemented in cooperation, the thickness of the pressed part of the elastomer (12 or 22) is reduced. However, the portion, which is not pressed by the pressing wall (13 or 23), of the elastomer (12 or 22) will press against an inner wall of the grooves (11 or 21) in which the elastomer (12 or 22) is received, meeting the airtight requirements required for the electroacoustic device. However, the invention comprises been described by way of example in which the elastomer (12 or 22) comprises a preferable amount of deformation, and when the elastomer (12 or 22) does not have a preferable amount of deformation, the airtight requirement required for the electroacoustic device is met by pressing the elastomer (12 or 22) with the pressing wall (13 or 23). In one embodiment, an apex of the elastomer (12 or 22) is not higher than a top edge of the groove (11 or 21) to reduce push-off during subsequent operations. Furthermore, in another embodiment, when the body shell 100 of the invention is provided with a plurality of airtight regions 101, one of the at least two half-shells 10, 20 may be implemented with the groove (11 or 21) or the pressing wall (13 or 12) in a different airtight region 101, respectively, and the invention does not limit the structure of the same half-shell (10 or 20) in the plurality of airtight regions 101 to be the same.

Therefore, when the two half-shells 10, 20 are assembled, the pressing wall (23 or 13) presses the elastomer (12 or 22) in the groove (11 or 21), so that the elastomer (12 or 22) is completely filled in the groove (11 or 21), external air or moisture is reduced from entering the shell 100, and the airtight structure is formed. At the same time, the airtight structure of the invention enables the body shell 100 to have an anti-vibration effect by virtue of the shock-absorbing property of the elastomer (12 or 22). Therefore, the invention is not applied with EVA foaming foam or gel, but is implemented through the airtight structure created by the elastomer (12 or 22) and the pressing wall (23 or 13) together to improve the problem encountered in conventional processing.

In one embodiment, the groove (11 or 21) of the invention is formed between two spaced walls (14 or 24) extending from one of the at least two half-shells 10, 20 to the other of the at least two half-shells 20, 10, the two walls (14 or 24) serving as groove walls for the groove (11 or 21), respectively and limiting the position of the elastomer (12 or 22). Further, in another embodiment, the two half-shells 10, 20 may be formed with the two walls (14 or 24), respectively, and the two walls (14 or 24) of the same half-shell (10 or 20) are staggered with the two walls (24 or 14) of the other half-shell (20 or 10), so that at least one of the walls (14 or 24) of one of the half-shells (10 or 20) can serve as the pressing wall (13 or 23) for pressing the elastomer (22 or 12) on the other half-shell (20 or 10).

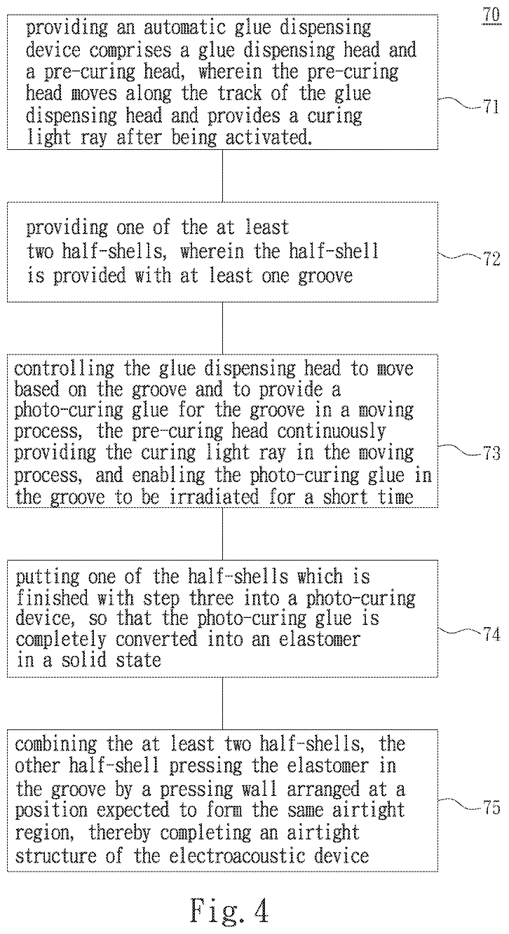

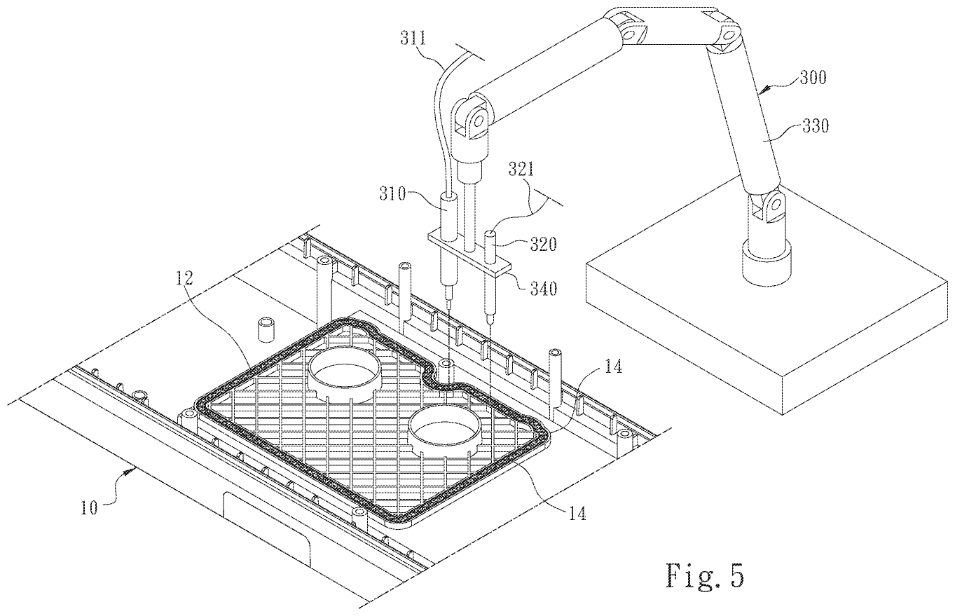

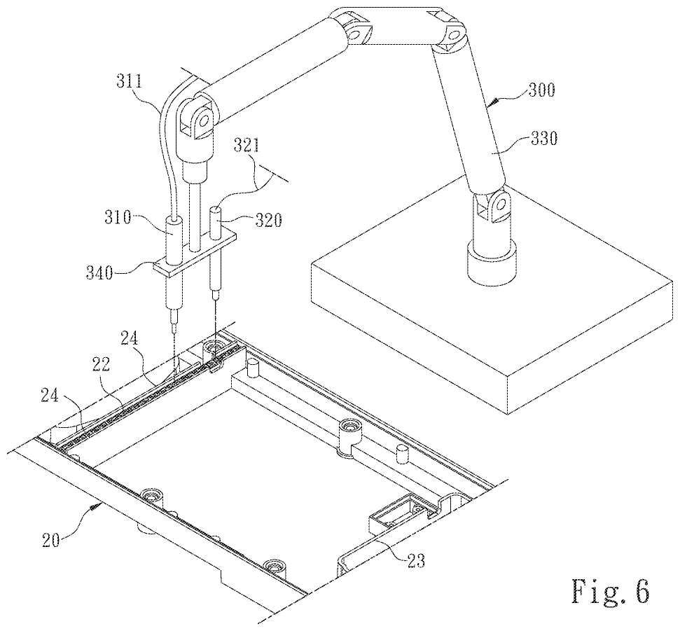

In addition to the foregoing, the invention also provides a forming method 70 for forming the hermetic structure in combination with FIG. 4 to FIG. 8, the forming method 70 comprising:

step one 71: providing an automatic glue dispensing device 300, wherein the automatic glue dispensing device 300 comprises a glue dispensing head 310 and a pre-curing head 320, the pre-curing head 320 moves along a track of the glue dispensing head 310, and a curing light ray 322 is provided after the pre-curing head 320 is started;

step two 72: providing one of the at least two half-shells 10, 20, wherein the half-shell (20 or 20) is provided with at least one groove (11 or 21) at a position expected to form the airtight region 101;

step three 73: controlling the glue dispensing head 310 to move based on the groove (11 or 21) and to provide a photo-curing glue 312 for the groove (11 or 21) in a moving process, the pre-curing head 320 continuously providing the curing light ray 322 in the moving process, and enabling the photo-curing glue 312 in the groove (11 or 21) to be irradiated for a short time;

step four 74: putting one of the half-shells (10 or 20) which is finished with step three into a photo-curing device 400, so that the photo-curing glue 312 is completely converted into an elastomer (12 or 22) in a solid state; and

step five 75: combining the at least two half-shells 10, 20, the other half-shell (10 or 20) pressing the elastomer (12 or 22) in the groove (11 or 21) by a pressing wall (23 or 13) arranged at a position expected to form the same airtight region 101, thereby completing an airtight structure of the electroacoustic device.

In detail, initially, the automatic glue dispensing device 300 is provided, and the automatic glue dispensing device 300 comprises the glue dispensing head 310 and the pre-curing head 320, wherein the glue dispensing head 310 and the pre-curing head 320 can be respectively arranged on different mechanical arms, or can be arranged on a holder 340 arranged on the same mechanical arm 330 at an end of the mechanical arm 330. In one embodiment, the mechanical arm 330 of the invention comprises a load capacity of 6 kg and a working range of 1000 mm, thereby allowing the glue dispensing head 310 and the pre-curing head 320 to be disposed thereon and satisfying the moving requirements of the glue dispensing head 310 and the pre-curing head 320. The glue dispensing head 310 is connected with a glue delivery pipe 311 and is driven when the mechanical arm 330 moves. The glue dispensing head 310 receives the photo-curing glue 312 from the glue delivery pipe 311 and supplies the photo-curing glue 312 to the at least two half-shells 10, 20 after being started. The pre-curing head 320 moves along the track of the glue dispensing head 310, and the pre-curing head 320 and the glue dispensing head 310 can be moving synchronously or asynchronously. The pre-curing head 320 is connected to a power line 321 and activated to provide the curing light ray 322 after receiving power from the power line 321. In one embodiment, the curing light ray 322 comprises a wavelength of 280 nm to 400 nm. The curing light ray 322 is ultraviolet light and comprises an illumination intensity greater than 50 mW/cm². In one embodiment, the exposure time of the photo-curing glue 312 under the curing light ray 322 provided by a LED ultraviolet light lamp is greater than 0.5 seconds, wherein the power rate of the LED ultraviolet light lamp is greater than 30 W. In another embodiment, the exposure time of the photo-curing glue 312 under the curing light ray 322 provided by a mercury ultraviolet light lamp is greater than 1 second, wherein the power rate of the mercury ultraviolet light lamp is greater than 30 W.

Next, entering step two 72, one of the at least two half-shells 10, 20 is provided, the base structure of the at least two half-shells 10, 20 is the same as described above, but it should be understood that the at least two half-shells 10, 20 in step two 72 are not yet provided with the photo-curing glue 312.

In step three 73, the glue dispensing head 310 is controlled to move based on the groove (11 or 21) and to provide the photo-curing glue 312 to the groove (11 or 21) in the moving process, the pre-curing head 320 and the tack head 310 are maintained at a constant velocity during the moving process, e.g., 40 mm/s, the pre-curing head 320 continues to provide the curing light ray 322 during the moving process, and the photo-curing glue 312 in the groove (11 or 21) is irradiated for a short time, so that the photo-curing glue 312 can be preliminarily set. To be preliminarily set means that the photo-curing glue 312 is changed from a liquid state to a state with a basic shape and cannot be deformed or flowed again. Therefore, through the implementation of step three 73 of the invention, the curing time required by step four 74 can be effectively shortened, and meanwhile, the problem of poor products in subsequent operation caused by the fact that the uncured photo-curing glue 312 is accidentally collided with during the transportation process of the at least two half-shells 10, 20 after glue dispensing is avoided.

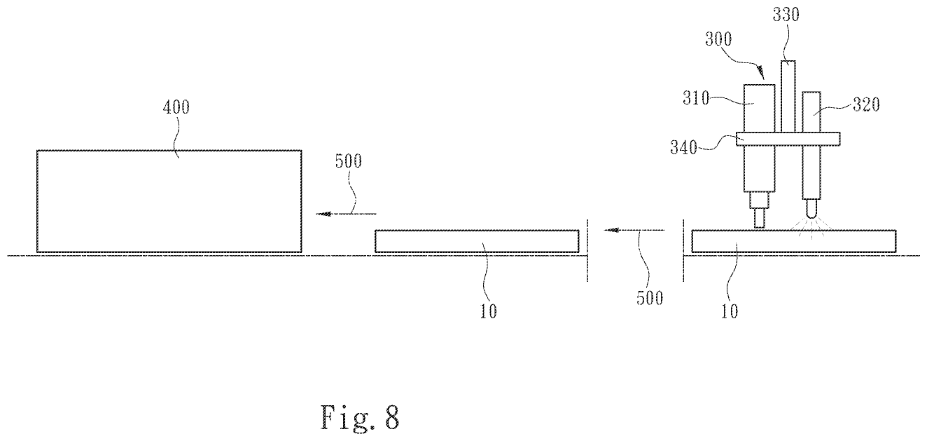

Proceeding to step four 74, one of the half-shells (10 or 20) which is completed with step three 73 is placed into the photo-curing device 400 (shown by arrow 500 in FIG. 8, for example), which applies the curing light ray 322 to the half-shell (10 or 20). After the energy on the photo-curing glue 312 comprises accumulated to a certain energy (for example, 1500 mJ/cm² to 2000 mJ/cm²), the photo-curing glue 312 is completely converted into the elastomer (12 or 22) in a solid state. It should be understood that although the invention performs the pre-curing at step three 73, the time for which the photo-curing glue 312 receives the curing light ray 322 at step four 74 is significantly longer than the time for which the photo-curing glue 312 receives the curing light ray 322 at step three 73. Further, when the photo-curing glue 312 contains two photo-initiators, the curing light ray 322 projected by the pre-curing head 320 may differ slightly from the curing light ray 322 projected by the photo-curing device 400, and the difference may be in wavelength or in illumination intensity. After that, the at least two half-shells 10, 20 are combined so that the other half-shell (20 or 10) presses the elastomer (12 or 22) in the groove (11 or 21) with the pressing wall (23 or 13) to complete the airtight structure of the electroacoustic device.

As can be seen from the foregoing, the forming method 70 of the invention is implemented through the automatic glue dispensing device 300 to solve the problem caused by the need to first cut the EVA foamed foam when the conventional electroacoustic device is applied to the EVA foamed foam. Furthermore, the forming method 70 also improves the situation that conventional EVA foaming foam can only be operated manually. In addition, according to the forming method 70 of the invention, through the use of the photo-curing glue 312 and photo-curing process, the photo-curing glue 312 is completely converted into the elastomer (12 or 22) through the use of photo-curing, thereby improving the problem that the conventional glue and the EVA foaming foam cannot be used for airtight purposes. In addition, the invention further utilizes the pre-curing head 320 to briefly irradiate the photo-curing glue 312 so that the photo-curing glue 312 can be preliminarily set in the groove (11 or 21) and the time required for subsequent complete conversion of the photo-curing glue 312 into the elastomer (12 or 22) is reduced.

What is claimed is:

1. A method for forming an airtight structure of an electroacoustic device, the electroacoustic device comprising a body shell composed of at least two half-shells and set with at least one airtight region, the method comprising the following steps:
step one: providing an automatic glue dispensing device, wherein the automatic glue dispensing device comprises a glue dispensing head and a pre-curing head, the pre-curing head moves along a track of the glue dispensing head, and a curing light ray is provided after the pre-curing head is started;
step two: providing one of the at least two half-shells, wherein the half-shell is provided with at least one groove at a position expected to form the airtight region;
step three: controlling the glue dispensing head to move based on the groove and to provide a photo-curing glue for the groove in a moving process, the pre-curing head continuously providing the curing light ray in the moving process, and enabling the photo-curing glue in the groove to be irradiated for a short time;
step four: putting one of the half-shells which is finished with step three into a photo-curing device, so that the photo-curing glue is completely converted into an elastomer in a solid state; and
step five: combining the at least two half-shells, the other half-shell pressing the elastomer in the groove by a pressing wall arranged at a position expected to form the same airtight region, thereby completing an airtight structure of the electroacoustic device.

2. The method for forming an airtight structure of an electroacoustic device according to claim 1, wherein the groove is formed between two spaced walls.

3. The method for forming an airtight structure of an electroacoustic device according to claim 2, wherein the curing light ray comprises a wavelength in a range from 280 nm to 400 nm and an illumination intensity of more than 50 mW/cm².

4. The method for forming an airtight structure of an electroacoustic device according to claim 3, wherein at least one of the two walls serves as the pressing wall for pressing the elastomer on the other half-shell.

5. The method for forming an airtight structure of an electroacoustic device according to claim 4, wherein the curing light ray comprises a wavelength in a range from 280 nm to 400 nm and an illumination intensity of more than 50 mW/cm².

6. The method for forming an airtight structure of an electroacoustic device according to claim 1, wherein the pre-curing head moves in synchronization with the glue dispensing head.

7. The method for forming an airtight structure of an electroacoustic device according to claim 6, wherein the curing light ray comprises a wavelength in a range from 280 nm to 400 nm and an illumination intensity of more than 50 mW/cm².

8. The method for forming an airtight structure of an electroacoustic device according to claim 6, wherein the automatic glue dispensing device comprises a mechanical arm and a holder provided at an end of the mechanical arm, and the glue dispensing head and the pre-curing head are both provided on the holder.

9. The method for forming an airtight structure of an electroacoustic device according to claim 8, wherein the curing light ray comprises a wavelength in a range from 280 nm to 400 nm and an illumination intensity of more than 50 mW/cm².

10. The method for forming an airtight structure of an electroacoustic device according to claim 1, wherein an apex of the elastomer is not higher than a top edge of the groove.

11. An airtight structure of an electroacoustic device, the electroacoustic device comprising a body shell composed of at least two half-shells and set with at least one airtight region, the airtight structure of the electroacoustic device comprising:
one of the at least two half-shells being provided with an elastomer arranged in a groove at a position expected to form the airtight region, the other of the at least two half-shells being provided with a pressing wall at a position expected to form the same airtight region, when the at least two half-shells are assembled, the pressing wall pressing the elastomer in the groove to form the airtight structure, wherein the elastomer is formed by a photo-curing glue which is arranged in the groove and is completely cured.

12. The airtight structure of an electroacoustic device according to claim 11, wherein the groove is formed between two spaced walls.

13. The airtight structure of an electroacoustic device according to claim 11, wherein at least one of the two walls serves as the pressing wall for pressing the elastomer on the other half-shell.

14. The airtight structure of an electroacoustic device according to claim 11, wherein an apex of the elastomer is not higher than a top edge of the groove.
